(19) United States
(12) Patent Application Publication
(10) Pub. No.: US 2024/0100650 A1
(43) Pub. Date: Mar. 28, 2024

(54) AUTOMATED DETECTION OF TOOL GLAZING IN FLOOR GRINDERS

(71) Applicant: HUSQVARNA AB, Huskvrna (SE)

(72) Inventors: Linus Ottosson, Norsholm (SE); Andreas Jönsson, Hallsberg (SE)

(21) Appl. No.: 18/267,944

(22) PCT Filed: Dec. 17, 2021
(86) PCT No.: PCT/SE2021/051276

§ 371 Date: Jun. 16, 2023

(30) Foreign Application Priority Data
Dec. 18, 2020 (SE) 2051499-8
Mar. 1, 2021 (SE) 2150217-4

(51) Int. Cl. B24B 49/10; B24B 7/18; B24B 49/00; B24B 49/16; B24B 55/02; B24B 55/10

(52) U.S. Cl. CPC B24B 49/10; B24B 7/18; B24B 49/006; B24B 49/16; B24B 55/02; B24B 55/102

(57) ABSTRACT

A floor grinder (100), comprising at least one motor (110, 120) arranged to rotatably drive one or more abrasive grinding tool holders (130), and a control unit (140) arranged to monitor an operating characteristic of the floor grinder, wherein the control unit is arranged to compare the monitored operating characteristic to a pre-determined set of operating characteristics indicative of a tool glazing condition, and to trigger an action in case the monitored operating characteristic is indicative of a tool glazing condition, wherein the control unit is arranged to monitor the operating characteristic of the floor grinder using a machine learning technique and a glazing model configured using a plurality of examples of floor grinders which have experienced various degrees of glazing.

### TECHNICAL FIELD

The present disclosure relates to floor grinders for processing concrete surfaces. There are disclosed machines, methods, control units, and systems for detection of an imminent or already occurred tool glazing event. Some of the disclosed methods may be advantageously implemented using machine learning methods.

### BACKGROUND

Concrete surfaces are commonly used for flooring in both domestic and industrial facilities. The size of concrete surface floors ranges from a few square meters for a domestic garage floor to thousands of square meters in larger industrial facilities. Concrete surfaces offer a cost efficient and durable flooring alternative and have therefore gained popularity over recent years.

A floor grinder can be used to efficiently process a concrete surface in order to, e.g., obtain a level surface and/or a surface having a desired surface texture. Floor grinders can also be used to polish concrete surface in order to obtain a glossy surface finish.

Glazing refers to an undesired effect where the abrasive cutting segments on the floor grinder become dull and stop grinding efficiently. Glazing occurs when the cutting segment matrix holding the abrasive particles overheat and cover the abrading particles, which often comprise diamond granules.

Experienced operators are normally able to detect when glazing occurs due to a change in overall tool feel during operation. However, inexperienced operators and automated systems may not have this ability to detect when glazing events occur and take appropriate action.

WO 2017215943 A1 shows a floor grinding machine arranged to monitor an operating characteristic of the floor grinder and to compare the monitored operating characteristic to a pre-determined set of operating characteristics. However, there is still a need for an improved automated system for detection of tool glazing.

### SUMMARY

It is an object of the present disclosure to provide improved floor grinding machines arranged to detect a glazing condition, and to trigger one or more mitigating actions in response to detecting a glazing event.

This object is obtained by a floor grinder comprising at least one motor arranged to rotatably drive one or more abrasive grinding tool holders, and a control unit arranged to monitor an operating characteristic of the floor grinder. The control unit is arranged to compare the monitored operating characteristic to a pre-determined set of operating characteristics indicative of a tool glazing condition, and to trigger an action in case the monitored operating characteristic is indicative of a tool glazing condition. The control unit is arranged to monitor the operating characteristic of the floor grinder at least in part by using a machine learning technique and a glazing model configured using a plurality of examples of floor grinders which have experienced various degrees of glazing.

Thus, automated detection of imminent or ongoing glazing is achieved. The control unit is also configured to trigger an action to mitigate the effects of the glazing event. The control unit mimics an experienced operator which is able to detect glazing before it becomes a real issue, and as will be discussed in more detail below, also take corrective action to mitigate the effects of the glazing, and often avoid glazing entirely.

The training of the glazing model can be performed off-line under controlled circumstances, and the glazing model can then be stored in a memory module of the tool. Thus, the tool glazing detection mechanism can easily be tailored to a given type of floor grinder and/or to a given type of abrasive set of concrete processing tools. Also, several fault models can be stored in the memory module of the floor grinder, and a suitable fault model can be selected in dependence of the type of grinder and abrasive tool which is currently being used. A selection of glazing model can be made in dependence of the type of tool currently being used. Since the glazing model is tailored to a given type of tool, a more reliable and accurate detection of tool glazing can be obtained.

According to aspects, the action comprises triggering generation of a warning signal to an operator. Thus, even unexperienced operators become aware that there is a risk of glazing or that glazing has already occurred.

According to aspects, the action comprises controlling at least one of the motors to reduce a rotation velocity of the one or more grinding tool holders. By reducing tool velocity, glazing can often be avoided. Thus, the overall risk of glazing is reduced.

According to aspects, the action comprises increasing an amount of water added to the grinding process. This increases the cooling effect by the water on the abrasive tools, which reduces the risk of glazing.

According to aspects, the action comprises controlling a pressure applied to the one or more grinding tool holders. As for tool velocity, control of pressure in response to detecting an increased risk of tool glazing is likely to reduce the risk, and possibly avoid glazing altogether.

According to aspects, the action comprises bringing the floor grinder to a halt. By bringing the machine to a halt, damage to the machine and to the concrete surface is avoided. Also, unnecessary power consumption is avoided.

According to aspects, the action comprises triggering a pulsed drive mode by the at least one motor. This pulsed drive mode may reverse the glazing, thereby avoiding the glazing event.

According to aspects, the monitored operating condition comprises a power consumption of the at least one motor, where a decrease in power consumption is indicative of a glazing condition. Motor power consumption can be reliably measured on most machines, e.g., by measuring consumed electrical current. Thus, a legacy floor grinder can be retro-fitted with a new control unit arranged to detect glazing conditions, and trigger actions in response to such detections.

According to aspects, the at least one motor is configured to generate a constant drive torque. The monitored operating condition comprises a rotation velocity of the one or more grinding tool holders, where an increase in rotation velocity is indicative of a glazing condition. Rotation velocity can be measured directly by observing electric motor currents, or by using some form of tool speed sensor, such as a Hall effect sensor or the like. This type of detection principle is low cost yet reliable, which is an advantage.

According to aspects, the at least one motor is configured to drive the one or more grinding tool holders at a constant rotation velocity. The monitored operating condition comprises a drive torque applied by the at least one motor, where a decrease in drive torque is indicative of a glazing condition. Drive torque data can also be directly obtained from the electric motor control, or from an external sensor mounted on a drive shaft or the like. As for detection based on rotation velocity, this detection mechanism presents a relatively low cost yet reliable method for detecting onset of glazing.

According to aspects, the floor grinder comprises a sensor configured to detect an amount of generated dust by the floor grinder, wherein the monitored operating condition comprises the amount of generated dust, where a decrease in the amount of generated dust is indicative of a glazing condition. By observing the amount of generated dust, it becomes relatively straight forward to detect when the floor grinder is not grinding properly. One common reason for reduced grinding efficiency is tool glazing. This detection mechanism can advantageously be complemented by tool segment pressure sensors and electronic spirit levels to make sure that the reduction in generated dust is not due to other reasons, such as a tilting of the machine.

According to aspects, the floor grinder comprises a sensor configured to detect vibration generated by the floor grinder. The monitored operating condition comprises the generated vibration, where a change in vibration frequency content is indicative of a glazing condition. Changes in vibration signature by the machine can be reliably detected based on machine learning methods, as will be explained herein. The same principles can be applied to audible sound data, captured by a microphone sensor.

There is also disclosed herein a concrete surface processing system comprising the floor grinder, and also a dust extractor connected to the floor grinder via a dust collection hose. The dust extractor may comprise a dust sensor arranged to determine an amount of generated dust, and/or a rate at which dust is currently being generated. This data can then be sent to the control unit on the floor grinder, which may use the data in detecting onset of a glazing condition. In particular, the dust extractor may comprise a sensor arranged to determine a weight of collected dust, and/or a dust particle density sensor arranged to measure a density of dust particles in an incoming air flow to the dust extractor.

There are also disclosed herein control units and power tools associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 illustrates an example floor grinder;

FIGS. 2A-B illustrate another example floor grinder;

FIG. 3 shows an abrasive grinding tool;

FIGS. 4A-B are graphs showing undesired operating regions;

FIG. 5 illustrates an example floor grinder;

FIG. 6 is a functional view of a glazing detection system;

FIG. 7 illustrates a dust extractor comprising dust sensors;

FIG. 8 shows an example remote control device;

FIG. 9 shows an example wireless device;

FIG. 10 is a flow chart illustrating methods;

FIG. 11 schematically illustrates a control unit; and

FIG. 12 schematically illustrates a computer program product.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

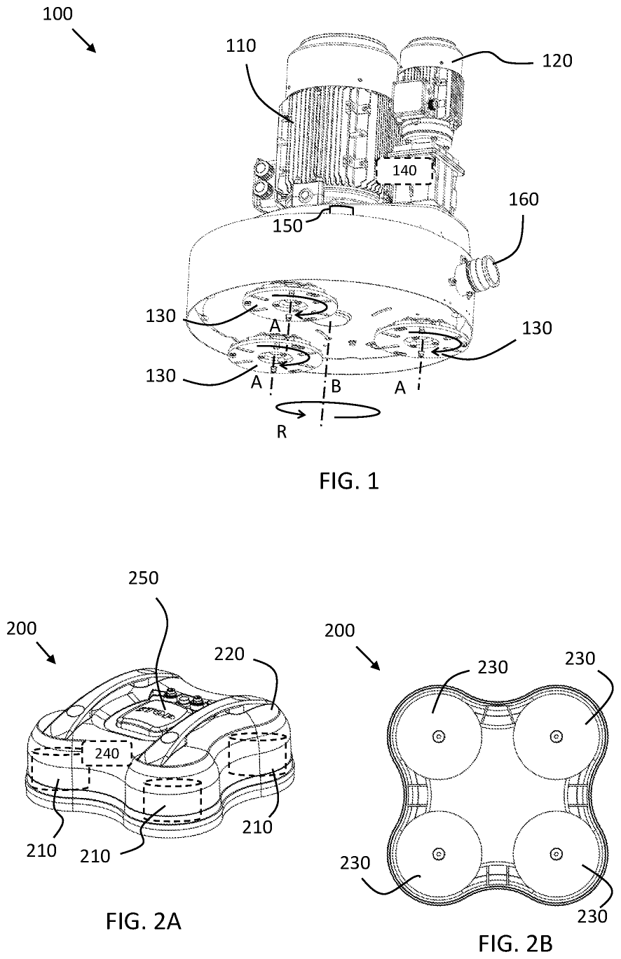

FIG. 1 illustrates details of an example floor grinder 100. The floor grinder 100 comprises a first electric motor 110 arranged to rotatably drive a number of tool holders 130 about respective axes A. Abrasive tools of varying grit and specifications can be mounted onto the tool holders 130. The tool holders 130 on the example machine 100 are comprised on a rotatable body section. This body section is often referred to as a planet. A second electric motor 120 is arranged to rotate the planet about a central axis B. The type of drive system shown in FIG. 1 is generally referred to as a planetary drive system.

Electrically powered floor grinders like that illustrated in FIG. 1 are generally known. Floor grinders driven by combustion engines, such as propane-fueled combustion engines, are also known.

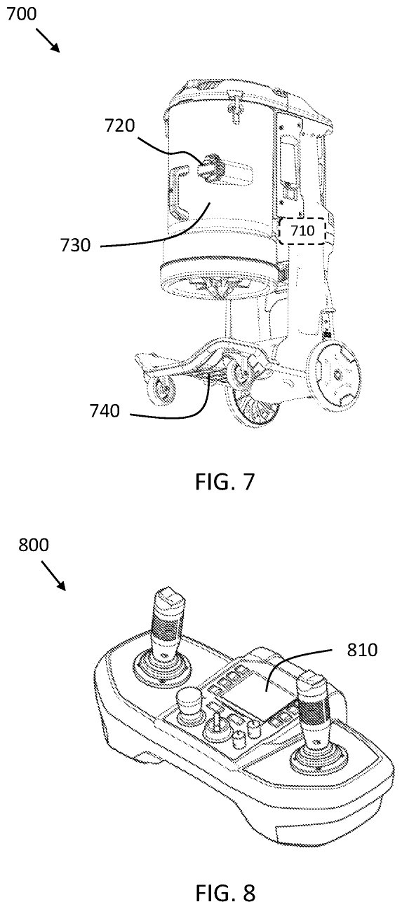

The floor grinder 100 comprises a control unit 140 connected to the electric motors 110, 120, and optionally to one or more sensors 150 arranged on the floor grinder. These sensors may comprise vibration sensors, acoustic sensors, temperature sensors, and also dust sensors arranged in the dust outlet 160 of the machine to measure how much dust that is currently being generated by the floor grinder when processing the concrete surface. A dust sensor may, e.g., comprise a photodiode arranged in the dust outlet 160. A large amount of dust passing the outlet causes a weaker signal from the photo diode, and vice versa. Other types of dust sensors will be discussed below in connection to FIG. 7.

The motor arranged to drive the tool holders 130 may be a permanent magnet synchronous motor (PMSM) which is an alternating current (AC) synchronous motor whose field excitation is provided by permanent magnets, and which has a sinusoidal counter-electromotive force (counter EMF) waveform, also known as back electromotive force (back EMF) waveform. PMSM motors are known in general and will therefore not be discussed in more detail herein. For instance, similar electrical motors including associated control methods are discussed in “Electric Motors and Drives” (Fifth Edition), Elsevier, ISBN 978-0-08-102615-1, 2019, by Austin Hughes and Bill Drury. Other types of electrical machines can also be used with a floor grinder such as that in FIG. 1. For most electrical machines, it is relatively straight forward to determine a current speed of rotation of the motor axle, and also the current torque generated at the motor axle.

One reason the herein disclosed methods are so effective at detecting a fault state, and also classifying different fault states, is that the motor current can be monitored. A change in back-EMF (electromagnetic force) by the electric machine used to drive the rotatable tool due to a given fault state will be immediately visible in the motor current drawn over the interface.

FIGS. 2A and 2B illustrate another type of floor grinder. This floor grinder is arranged for remote controlled or autonomous floor grinding operations. The machine 200 is supported on the concrete surface by four rotatable grinding tools. Each tool is held by a respective tool holder 230, and each tool holder is rotatably driven by an electric machine 210. There are four tool holders in the machine illustrated in FIGS. 2A and 2B, but three tool holders, or more than four tool holders are also possible. The electric motors 210, and a control unit 240 arranged to control the grinding operation, are enclosed in a body 220. A stop button 250 on the top of the machine 200 is accessible by an operator. This stop-button may also comprise means for generating a visible warning signal or a notification signal, such as a red light emitting diode (LED) for a warning signal and a yellow LED for a notification signal. The machine 200 may be equipped for floor grinding or floor polishing, depending on the abrasive tools mounted onto the tool holders 230.

This particular machine 200 differs from known floor grinding machines in that it is relatively small in both size and weight and does not comprise any manual control means such as a manual control handle or the like which an operator can use to steer the machine. Instead, this machine is self-propelled and comprises an on-board control unit 240, which control the various operations of the machine without an operator having to go near the machine. The machine 200 may be associated with a total weight less than 30 kg, and preferably no more than 25 kg. The machine footprint, i.e., the part of the surface covered by the grinder, may be comprised in a square of dimensions 100 cm by 100 cm, and preferably no more than 70 cm by 70 cm. However, the glazing detection techniques discussed herein may also be used for more standard sized concrete surface processing machines.

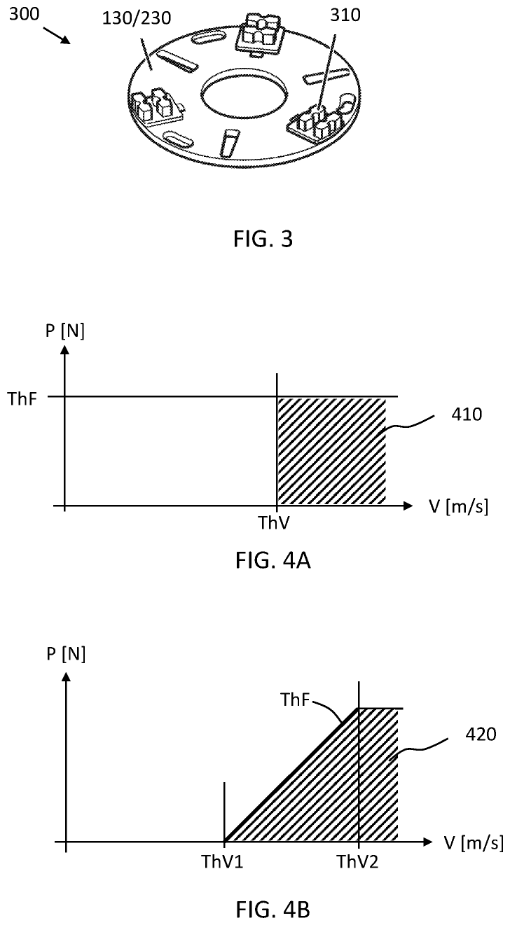

FIG. 3 illustrates an example tool holder 130, 230 for use with the machines 100, 200. The tool holder is arranged to hold tool segments 310 for abrasive operation. The tool segments may, e.g., comprise diamond granules or other abrasive particles embedded into a tool segment matrix.

Glazing refers to an effect where the abrasive tool segments 310 become dull and stop grinding. Glazing occurs when the tool segment matrix holding the abrasive particles overheat and cover the abrading particles, i.e., the diamonds. The risk of glazing is a function of the pressure P applied to the segment and the (tangential) velocity V of the segments 310 relative to the concrete surface. In particular, the risk of glazing increases if the tool segment is operated at high velocity and low pressure. With higher tool segment pressure, a larger tool segment velocity can normally be tolerated and vice versa. With reference to FIGS. 4A and 4B, there is an undesired operating region 410, 420 where the risk of glazing is increased. The size and shape of this undesired operating region depends on the type of abrasive segment an on the material to be processed. In FIG. 4A, the undesired operating region is defined by mutually independent thresholds ThV, ThF on speed V and pressure P, while, in FIG. 4B, the threshold ThF on pressure P is a function of the speed V (here exemplified by a linear function). By avoiding operation in the undesired region 410, 420, the risk of suffering a glazing condition is reduced. Also, if glazing is about to occur, the glazing event may be avoided if the machine is swiftly removed from its operating point in the undesired region 410, 420 and into a desired operating region 430. This can be achieved by either reducing tool velocity V or increasing tool pressure P, or by a combination of the two. Other parameters may of course also be adjusted if it is deemed that glazing is about to occur. For instance, the amount of water added during the grinding process can be increased to improve the cooling of the abrasive tool segments.

The floor grinder control units 140, 240 discussed herein monitor the operation of the floor grinder and are able to detect when glazing is about to occur and/or if glazing has already occurred. This is possible by monitoring a number of different operating characteristics of the floor grinder, as will be discussed in more detail below. For instance, power consumption by the one or more electric motors, changes in tool rotation speed or torque applied by a drive motor, vibrations, audible sound, and temperature are all examples of operating characteristics which normally change in connection to an onset of a glazing condition.

To generalize the discussion up till now, there is disclosed herein a floor grinder 100, 200, comprising at least one motor 110, 120, 210 arranged to rotatably drive one or more abrasive grinding tool holders 130, 230. The floor grinder also comprises a control unit 140, 240 arranged to monitor an operating characteristic of the floor grinder. The control unit is arranged to compare the monitored operating characteristic to a pre-determined set of operating characteristics indicative of a tool glazing condition, and to trigger an action in case the monitored operating characteristic is indicative of a tool glazing condition.

The triggered action may comprise controlling at least one of the motors 110, 120, 210 to reduce a rotation velocity of the one or more grinding tool holders 130, 230. This reduction in rotational velocity of the tool holders 130, 230 may alleviate the glazing tendency since a high tool velocity is associated with an increased tendency for tool glazing. With reference to FIG. 4A and FIG. 4B, the exact values for the thresholds ThV, ThV1 and ThV2 may not be known to the control unit 140, 240, and the threshold values for “safe” operation with respect to the risk of glazing can be dependent on many factors, including the type of concrete, the type of tool, current grit, tool wear, etc. Thus, the control unit may inadvertently configure a too high tool speed. However, by the present disclosure, the control unit is able to detect onset of a glazing condition and reduce the tool velocity before the glazing becomes fully established. A reduced tool velocity may alleviate the glazing effect and bring new fresh abrasive particles to the surface of the tool segments 310.

According to aspects, the triggered action may also comprise increasing an amount of water added to the grinding process. This increases the cooling effect by the water on the abrasive tools, which reduces the risk of glazing.

The control unit 140, 240 may also probe the current grinding set-up to find a suitable grinding tool speed, by slowly increasing the rotational velocity of the tool holders while monitoring operating characteristics of the floor grinder until onset of tool glazing is detected, whereupon tool speed can be reduced back down to a safe level. The control unit 140, 240 is thus able to maintain a relatively high tool speed without risk of glazing. In other words, the control unit 140, 240 is by the herein disclosed techniques able to optimize floor grinding tool speed, which is an advantage.

The triggered action may at least in part also be determined based on machine learning. This glazing avoidance action model is then trained to control various aspects of the machine operation, such as the rotation speed of the tool holders, pressure applied to the tool holders, amount of liquid applied to the contact patch between tool and surface, and so on. Thus, as the control unit 140, 240 detects onset of tool glazing, it also responds by one or more mitigating actions to avoid glazing.

The glazing avoidance action model can be implemented with advantage as a reinforcement learning technique, where an agent has been trained to control a machine in order to avoid a glazing condition. The reward function then comprises onset of glazing, and/or a measurable degree of glazing in different operating conditions. Other machine learning techniques may of course also be applied, such as neural networks.

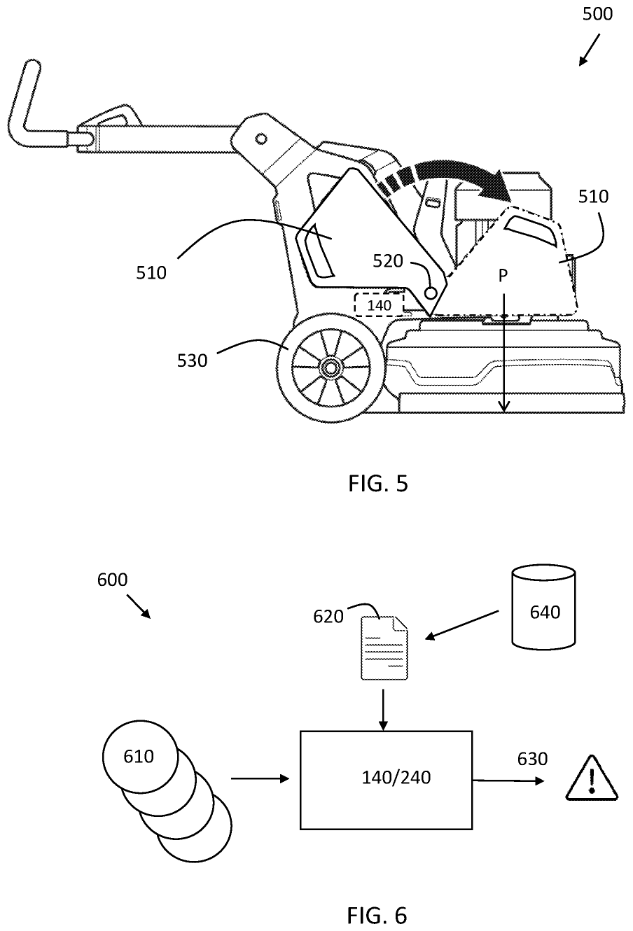

FIG. 5 shows an example floor grinder 500 with a weight 510 which can be configured to generate a variable pressure on the tool segments. This particular weight 510 is pivotably mounted on a trunnion 520, whereby the weight can be pivoted between a first position (shown in dashed line) associated with an increased pressure P on the tool segments, and a second position (shown in solid line) where most of the weight is instead supported by the wheels 530 of the floor grinder 500, which means that the pressure P on the tool segments is reduced. This pivoting angle of the weight 510 can be manually configured by an operator, or automatically by means of an electric motor, hydraulic actuator, or the like.

The control unit 140, 240 may be arranged to control the position of the weight 510 so as to vary the pressure P on the tool segments. If onset of glazing is detected, the pressure P on the tool segments can be increased, either directly by the control unit via an actuator, or by transmitting a message to an operator comprising a request to increase the weight on the tool segments.

Of course, other means of increasing and reducing pressure P on the tool segments can also be envisioned. For instance, the floor grinder may comprise a vertically arranged tap arranged to receive and to hold free weights, such as the type of discs used in weightlifting for personal exercise.

Regardless of whether the control unit 140, 240 controls the pressure P automatically or via requests to an operator, the action by the control unit may comprise controlling the pressure P applied to the one or more grinding tool holders 130, 230.

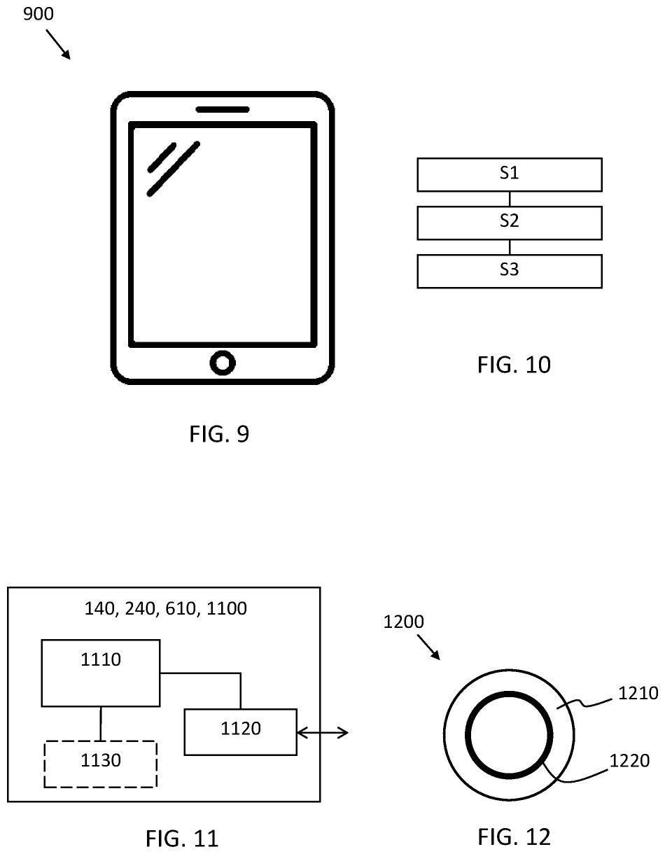

The triggered action may also comprise triggering the generation of a warning signal to an operator of the machine. This warning signal may, e.g., be a flashing warning light, perhaps integrated with a stop button 250 on a floor grinder like that shown in FIG. 2A. The warning signal may also be wirelessly transmitted to a remote control device 800 and shown on a display 810 of the remote control device such as illustrated in FIG. 8, or to some other type of wireless device, such as the tablet device 900 illustrated in FIG. 9.

Another action which may be suitable in case severe glazing is detected by the control unit 140, 240, is bringing the floor grinder to a halt, since grinding effect will be severely limited. The control unit 140, 240 then stops the motors 110, 120, 210, and optionally also signals the action to an operator. This signaling may comprise transmitting a wireless signal to a remote device such as a remote control device 810 or some other form of wireless device 910. The operator may then investigate the cause of the glazing event, perhaps service the machine, or configure different operating parameters by the machine.

According to some aspects, the control unit is arranged to trigger a pulsed drive mode by the at least one motor 110, 120, 210, such as a sequence of rapid changes in drive axle torque. This is because glazing may be alleviated by subjecting the tool segments to mechanical shock and vibration. By pulsing the supply current to an electric machine, or repeatedly applying a mechanical brake to the motor axle, vibration and mechanical shock may be generated by the control unit. These rapid pulses may shake loose some of the glazed material and bring new fresh abrasive particles to the surface of the tool segment.

There are several ways in which the control unit can infer that a glazing event is about to occur, and/or that at least some of the tool segments are suffering from a glazing condition.

FIG. 6 shows a functional view of a system 600 for detecting an imminent glazing condition and/or an ongoing glazing condition. The system comprises the control unit 140, 240 discussed above, configuration data 620 describing operating characteristics which are indicative of a glazing condition, and one or more sensors 610 which are used to monitor a current operating characteristic of the floor grinder. The control of an electric machine is considered equivalent to a sensor in this respect, since the control unit may obtain information related to applied torque, axle speed, drawn power, and the like. The control unit 140, 240 outputs a glazing condition detection 630, and optionally also one or more control signals to triggers actions by the floor grinder in response to detecting a glazing event. It is appreciated that detection of tool glazing can be based on one or more types of data, and that several different types of data can be combined in the detection for increased reliability and/or reduced detection latency. For instance, a first data type may be provided from control of an electric machine, e.g. from the power circuitry configured to drive the electric machine, a second type of data may be provided from a torque sensor arranged somewhere in the transmission between drive motor and tool holder or internally in the motor, a third data type may be provided from a tool speed sensor arranged to measure a rotation velocity of the tool. Temperature sensors, vibration sensors, acoustic sensors, and dust sensors may also be used with advantage to detect onset of a glazing condition.

The configuration data 620 may take on different forms depending on the type of detection principle applied. This data may comprise simple thresholds, or more advanced patterns for use with pattern matching algorithms. The configuration data may also comprise neural network structures or regression tree structures for use in machine learning-based detection, as will be discussed in more detail below.

The configuration data 620 may, as discussed above, be different for different types of tools, and for different types of floor grinding machines. The configuration data may be determined by, e.g., laboratory experimentation, by computer simulation, or by collection of data from field trials. The configuration data may also be based on gathered sensor data from actual confirmed glazing events. The operator may input a tool type to the control unit 140, 240, and the control unit can then select the appropriate configuration data 620 matched to the tool type. Alternatively, the control unit 140, 240 can be arranged to automatically select the appropriate configuration data 620 by reading identification means, such as a radio frequency identification (RFID) tag arranged on the tool.

The configuration data 620 may also be regularly updated by accessing a remote server 640, e.g., by wireless link. This update is then akin to a driver update, which can be performed regularly or triggered by notification from the remote server 640.

According to aspects, the monitored operating condition comprises a power consumption of the at least one motor 110, 120, 210, where a decrease in power consumption is indicative of a glazing condition. The power consumption can be measured in a relatively straight forward manner, e.g., by observing a consumed current by the drive motor or motors. The configuration data may in this case comprise a power threshold, or a rate of decrease in power consumption. The control unit then monitors the power consumption of the drive motor, and if this power consumption suddenly decreases a glazing condition may be declared 630. An imminent glazing condition may be detected by a decline in power consumption. This sensor may be complemented by an electric level sensor (electrical spirit level), or a tool segment pressure sensor arranged to measure the tool pressure P. Thus, changes in power consumption which are due to changes in tool segment operating pressure, or tool angle with respect to the concrete surface, can be disregarded.

According to aspects, the at least one motor is configured to generate a constant drive torque to drive the tool holders 130. The monitored operating condition may then comprise a rotation velocity of the one or more grinding tool holders, where an increase in rotation velocity is indicative of a glazing condition. Thus, if a sudden increase in tool speed is detected by the control unit, perhaps by comparing a time derivative or acceleration to a pre-configured threshold, then onset of tool glazing can be declared. This data may also be complemented by an electric level sensor or a tool segment pressure sensor. Thus, changes in rotation velocity which are due to changes in tool segment operating pressure, or tool angle with respect to the concrete surface, can be disregarded.

According to aspects, the at least one motor is configured to drive the one or more grinding tool holders 130, 230 at a constant rotation velocity. The monitored operating condition may then comprise a drive torque applied by the at least one motor, where a decrease in drive torque is indicative of a glazing condition. As for the change in rotation velocity, a sudden change in drive torque can be used to detect a glazing condition. What constitutes a sudden and significant change in drive torque is defined by the configuration data 620.

According to aspects, the floor grinder 100, 200, 500 comprises a sensor configured to detect an amount of generated dust by the floor grinder, and the monitored operating condition comprises the amount of generated dust. A decrease in the amount of generated dust is indicative of a glazing condition, since this indicates that the tool segments are not grinding as efficiently as expected. This dust sensor may be realized as a photo-diode or radar arranged in the dust outlet 160 of the floor grinder 100. The dust sensor may also be arranged on a dust extractor machine 700 remote from the floor grinder, which will be discussed in more detail below in connection to FIG. 7.

According to some aspects, the floor grinder 100, 200, 500 also comprises a sensor configured to detect vibration generated by the floor grinder. The operating condition monitored by the control unit then comprises the generated vibration. A change in vibration frequency content is indicative of a glazing condition. The vibration data is advantageously transformed into frequency domain by, e.g., fast Fourier transform (FFT), and various key frequency components are investigated. The lack of energy at some key frequencies may be indicative of a glazing event, where these key frequency components are generated from a grinding operation by the tool. This grinding operation of course ceases when glazing occurs, and therefore also the corresponding frequency content is reduced in power.

According to some related aspects, the floor grinder 100, 200, 500 comprises a sensor configured to detect audible sound generated by the floor grinder. The monitored operating condition may then comprise the audible sound, where a change in sound frequency content is indicative of a glazing condition.

The detection mechanisms based on the sensor signals may advantageously be based on machine learning techniques, and in particular based on the vibration and acoustic sensors, as well as on the data associated with control of the electric machines. Different types of machine learning techniques have been applied with success, but it has been found that algorithms based on random forest techniques are particularly effective and provide robust prediction of glazing condition. Various types of neural networks may also be applied with success to this classification task.

Random forests or random decision forests represent an ensemble learning method for classification, regression and other tasks that operate by constructing a multitude of decision trees at training time and outputting the class that is the mode of the classes (classification) or mean/average prediction (regression) of the individual trees. Random decision forests are associated with the advantage of being able to correct for decision trees' habit of overfitting to their training set. Random forests generally outperform decision tree-based algorithms.

As an alternative to random forest classification methods, a less complex decision tree algorithm can be used, often referred to as regression tree algorithms, which is basically a single tree random forest algorithm.

The machine learning techniques used herein comprise the construction of a glazing model which can be configured, i.e., “trained”, using a plurality of examples of floor grinders which have experienced various degrees of glazing. Measurement data of one or more parameters related to the operation of the floor grinders is stored and tagged with a respective glazing event state, which data is then used to train the glazing model in a training phase. The thus configured glazing model can then be fed by measurement data in real-time during operation of the floor grinder. If the floor grinder experiences an operating condition similar to one or more of the training examples, then the glazing model is likely to classify the tool as being associated with a glazing condition. The glazing model is not only able to determine that a given abrasive tool experiences a glazing condition, but it may also be configured to determine when a glazing event is imminent, i.e., is likely to occur in a near future.

Training of a machine learning model for glazing condition classification is advantageously done using a hold-out dataset, where one part of the data set is used to train the model, and another part is used for verification of the trained model.

Some aspects of the herein discussed glazing detection methods differ from the prior art since the detection mechanisms are based on training using machines with tools that have experienced glazing. The reasons for the glazing may not be entirely known, nor its physical implications on parameters that can be measured, such as vibration and the like. However, by training a glazing model to recognize the onset of glazing, a proper course of action can be taken to alleviate the consequences of the onset of glazing, and potentially reverse the tendency for glazing.

The glazing model may, as discussed above, use various parameters associated with the electric motor, such as drawn current by the motor on the different motor phases. However, detection performance and prediction may be improved if additional sensor input signals are also used in combination with the electric motor parameter measurements.

Signals from at least one inertial measurement unit (IMU) attached to the floor grinder may be used to pick up vibration patterns which may be indicative of an imminent or ongoing glazing condition. Microphones may be used to detect vibration in the frequency range of audible sound.

Temperature sensors arranged in connection to key components on the floor grinder may also provide valuable information which allows the machine learning algorithm to pick up patterns in the measurement data which is indicative of glazing.

FIG. 7 shows a dust extractor 700 which may be combined with some of the floor grinders discussed above, in particular with the floor grinder 100 in FIG. 1 and the floor grinder 500 FIG. 5, in a concrete surface processing system comprising the floor grinder 100 and the dust extractor 700 connected to the floor grinder via a dust collection hose. The dust extractor 700 is optionally arranged to measure an amount of dust generated by the floor grinder, and to transmit data associated with the amount of dust to the control unit 140. There are several ways in which to measure the amount of dust collected by the dust extractor as function of time. Generally, if the floor grinder stops generating dust, or if the amount of generated dust suddenly decreases, then this is indicative of a glazing condition. The criteria for detecting glazing condition based on the generated dust may be different for different types of tools and for different types of machines, thus, a configuration may be required.

According to some aspects, the dust extractor 700 comprises a sensor arranged to determine a weight of collected dust, and/or a dust particle density sensor arranged to measure a density of dust particles in an incoming air flow to the dust extractor. The dust weight sensor may be realized as a weight sensor arranged on a bottom plate 740 of the dust extractor, as shown in FIG. 7. A photo sensor or radar sensor may also be arranged to determine a density of dust particles in the incoming flow of air entering via the hose 720, or inside the cyclone separator 730 of the dust extractor.

The dust extractor 700 comprises a control unit 710 arranged to communicate with the control unit on the floor grinder.

FIGS. 8 and 9 show wireless devices 800, 900 which may be communicatively coupled to the control unit 140, 240 on the floor grinder, and/or to the control unit 710 on the dust extractor 700. The wireless device may display warnings of imminent glazing events, or information about an onset of a tool glazing condition. The remote control device 800 may also comprise control options for generating glazing event countermeasures, such as reducing the tool speed, increasing the pressure P on the tool segments (as exemplified in FIG. 5), or applying a temporary pulsed drive by the one or more motors.

FIG. 10 is a flow chart which illustrates some of the above discussed methods for detecting onset of a glazing event. There is illustrated a method for processing a concrete surface by a floor grinder 100, 200, 500 comprising at least one motor 110, 120, 210 arranged to rotatably drive one or more abrasive grinding tool holders 130, 230. The method comprises monitoring S1 an operating characteristic of the floor grinder by a control unit 140, 240, comparing S2 the monitored operating characteristic to a pre-determined set of operating characteristics indicative of a tool glazing condition, and triggering S3 an action by the floor grinder in case the monitored operating characteristic is indicative of a tool glazing condition.

FIG. 11 illustrates a control unit 140, 240, 610, 1100 comprising processing circuitry 1110, a communications interface 1110 coupled to the processing circuitry 1110; and a memory 1130 coupled to the processing circuitry 1110, wherein the memory comprises machine readable computer program instructions that, when executed by the processing circuitry, causes the control unit to perform operations of:
monitoring an operating characteristic of the floor grinder by a control unit 140, 240,
comparing the monitored operating characteristic to a pre-determined set of operating characteristics indicative of a tool glazing condition, and
triggering an action by the floor grinder in case the monitored operating characteristic is indicative of a tool glazing condition.

FIG. 11 also schematically illustrates, in terms of a number of functional units, the general components of a control unit 140, 240, 610, 1100. Processing circuitry 1110 is provided using any combination of one or more of a suitable central processing unit CPU, multiprocessor, microcontroller, digital signal processor DSP, etc., capable of executing software instructions stored in a computer program product, e.g. in the form of a storage medium 1130. The processing circuitry 1110 may further be provided as at least one application specific integrated circuit ASIC, or field programmable gate array FPGA.

Particularly, the processing circuitry 1110 is configured to cause the floor grinder to perform a set of operations, or steps, such as the methods discussed in connection to FIG. 10 and the discussions above. For example, the storage medium 1130 may store the set of operations, and the processing circuitry 1110 may be configured to retrieve the set of operations from the storage medium 1130 to cause the device to perform the set of operations. The set of operations may be provided as a set of executable instructions. Thus, the processing circuitry 1110 is thereby arranged to execute methods as herein disclosed.

The storage medium 1130 may also comprise persistent storage, which, for example, can be any single one or combination of magnetic memory, optical memory, solid state memory or even remotely mounted memory.

The circuit may further comprise an interface 1120 for communications with at least one external device. As such the interface 1120 may comprise one or more transmitters and receivers, comprising analogue and digital components and a suitable number of ports for wireline or wireless communication.

The processing circuitry 1110 controls the general operation of the control unit 140, 240, 610, e.g., by sending data and control signals to the interface 1120 and the storage medium 1130, by receiving data and reports from the interface 1120, and by retrieving data and instructions from the storage medium 1130.

FIG. 12 illustrates a computer readable medium 1210 carrying a computer program comprising program code means 1220 for performing the methods illustrated in FIG. 10, when said program product is run on a computer. The computer readable medium and the code means may together form a computer program product 1200.

The invention claimed is:

1. A floor grinder, comprising a motor arranged to rotatably drive one or more abrasive grinding tool holders, and a control unit arranged to monitor an operating characteristic of the floor grinder, wherein the control unit is arranged to compare the monitored operating characteristic to a pre-determined set of operating characteristics indicative of a tool glazing condition, and to trigger an action in case the monitored operating characteristic is indicative of a tool glazing condition,
wherein the control unit is arranged to monitor the operating characteristic of the floor grinder using a machine learning technique and a glazing model configured using a plurality of examples of floor grinders which have experienced various degrees of glazing.

2. The floor grinder according to claim 1, wherein the action comprises triggering generation of a warning signal to an operator.

3. The floor grinder according to claim 1, wherein the action comprises controlling the motors to reduce a rotation velocity of the one or more abrasive grinding tool holders.

4. The floor grinder according to claim 1, wherein the action comprises controlling a pressure applied to the one or more abrasive grinding tool holders.

5. The floor grinder according to claim 1, wherein the action comprises bringing the floor grinder to a halt, triggering a pulsed drive mode by the motor, or increasing an amount of water added to the grinding process.

6. (canceled)

7. (canceled)

8. The floor grinder according to claim 1, wherein the monitored operating condition comprises a power consumption of motor, wherein a decrease in power consumption is indicative of a glazing condition.

9. The floor grinder according to claim 1, wherein the motor is configured to generate a constant drive torque, wherein the monitored operating condition comprises a rotation velocity of the one or more abrasive grinding tool holders, wherein an increase in rotation velocity is indicative of a glazing condition.

10. The floor grinder according to claim 1, wherein the motor is configured to drive the one or more abrasive grinding tool holders at a constant rotation velocity, wherein the monitored operating condition comprises a drive torque applied by the motor, wherein a decrease in drive torque is indicative of a glazing condition.

11. The floor grinder according to claim 1, comprising a sensor configured to:
detect an amount of generated dust by the floor grinder, wherein the monitored operating condition comprises the amount of generated dust, wherein a decrease in the amount of generated dust is indicative of a first glazing condition,
detect vibration generated by the floor grinder, wherein the monitored operating condition comprises the generated vibration, wherein a change in vibration frequency content is indicative of a second glazing condition, or
detect audible sound generated by the floor grinder, wherein the monitored operating condition comprises the audible sound, wherein a change in sound frequency content is indicative of a third glazing condition.

12. (canceled)

13. (canceled)

14. The floor grinder according to claim 1, wherein the control unit is arranged to monitor a plurality of different operating characteristics of the floor grinder.

15. The floor grinder according to claim 14, wherein the plurality of different operating characteristics comprises at least two out of: a power consumption by the motor, a change in tool rotation speed or torque applied by a drive motor, vibrations, audible sound, and tool temperature.

16. The floor grinder according to claim 1, wherein the control unit is arranged to increase a rotational velocity of a tool holder while monitoring an operating characteristics of the floor grinder until onset of tool glazing is detected, whereupon the rotational velocity is reduced back down by an amount.

17. The floor grinder according to claim 1, wherein the control unit is arranged to detect tool glazing based on a combination of several different types of data.

18. The floor grinder according to claim 17, wherein a first data type is provided from control of an electric machine, a second type of data is provided from a torque sensor arranged somewhere in the transmission between drive motor and tool holder or internally in the motor, a third data type is provided from a tool speed sensor arranged to measure a rotation velocity of the tool.

19. A concrete surface processing system comprising the floor grinder of claim 1, and a dust extractor connected to the floor grinder via a dust collection hose.

20. The concrete surface processing system according to claim 19, wherein the dust extractor is arranged to measure an amount of dust generated by the floor grinder, and to transmit data associated with the amount of dust to the control unit.

21. The concrete surface processing system according to claim 20, wherein the dust extractor comprises a sensor arranged to determine a weight of collected dust, and/or a dust particle density sensor arranged to measure a density of dust particles in an incoming air flow to the dust extractor.

22. A method for processing a concrete surface by the floor grinder of claim 1, the method comprising
monitoring an operating characteristic of the floor grinder by the control unit,
comparing the monitored operating characteristic to a pre-determined set of operating characteristics indicative of the tool glazing condition, and
triggering an action by the floor grinder in case the monitored operating characteristic is indicative of the tool glazing condition.

23. A control unit comprising processing circuitry, a communications interface coupled to the processing circuitry; and a memory coupled to the processing circuitry, wherein the memory comprises machine readable computer program instructions that, when executed by the processing circuitry, causes the control unit to perform operations of:
monitoring an operating characteristic of the floor grinder by a control unit,
comparing the monitored operating characteristic to a pre-determined set of operating characteristics indicative of a tool glazing condition, and
triggering an action by the floor grinder in case the monitored operating characteristic is indicative of a tool glazing condition.

24. A floor grinder, comprising at least one motor arranged to rotatably drive one or more abrasive grinding tool holders, and a sensor configured to detect an amount of generated dust and/or slurry by the floor grinder, the floor grinder further comprising a control unit arranged to monitor the amount of generated dust and/or slurry, to compare the amount of generated dust and/or slurry to an amount of generated dust and/or slurry indicative of a tool glazing condition, and to trigger an action in case the amount of generated dust and/or slurry is indicative of a tool glazing condition.
